(19) United States
(12) Patent Application Publication
(10) Pub. No.: US 2013/0104761 A1
(43) Pub. Date: May 2, 2013

(54) SPRAYING AND PRINTING DEVICE

(71) Applicant: SHAO-KAI PEI, Tu-Cheng (TW)

(72) Inventor: SHAO-KAI PEI, Tu-Cheng (TW)

(73) Assignee: HON HAI PRECISION INDUSTRY CO., LTD., Tu-Cheng (TW)

(21) Appl. No.: 13/434,939

(22) Filed: Mar. 30, 2012

(30) Foreign Application Priority Data
Oct. 26, 2011 (TW) 100138990

(51) Int. Cl. B41F 1/40

(52) U.S. Cl. 101/324

(57) ABSTRACT

A spraying and printing device includes a supporting platform, a linear driving mechanism, a printing mechanism, and a spraying mechanism. The supporting platform is configured for placing a plurality of preprinted workpieces. The linear driving mechanism is mounted above the supporting platform, and includes a guiding rail and a moving member movably sleeved on the guiding rail. The printing mechanism is mounted to the moving member and positioned above the supporting platform. The printing mechanism includes at least one roller. The spraying mechanism is assembled to one end of the guiding rail and includes a plurality of spraying nozzles for spraying different dyes on the at least one roller. The at least one roller is driven by the moving member to slide along the guiding rail back and forth thereby printing different dyes on the workpieces.

### BACKGROUND

1. Technical Field

The present disclosure generally relates to spraying and printing devices, and particularly to a spraying and printing device capable of spraying various dyes continuously.

2. Description of Related Art

Commonly used spraying and printing devices may be only capable of spraying one dye, thus, when a soft substrate such as an electronic paper needs to be spayed and printed with various dyes, the soft substrate needs to be transferred from one spraying and printing device to another spraying and printing device. The transferring process may be time-consuming, and the spraying effect may not good.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 shows an isometric view of an embodiment of a spraying and printing device.

FIG. 2 shows an isometric view of a carrying disk of the spraying and printing device of FIG. 1.

FIG. 3 shows a clamping mechanism of the spraying and printing device of FIG. 1.

FIG. 4 shows a printing mechanism of the spraying and printing device of FIG. 1.

FIG. 5 shows a spraying mechanism of the spraying and printing device of FIG. 1.

### DETAILED DESCRIPTION

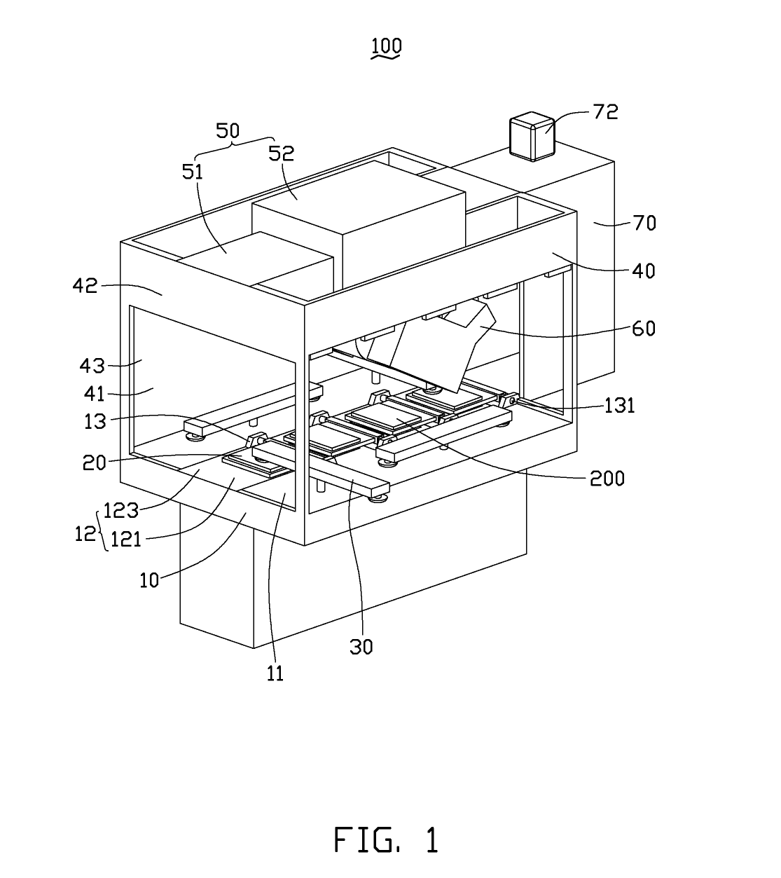

Referring to FIG. 1, an embodiment of a spraying and printing device 100 is shown. The spraying and printing device 100 is capable of spraying and printing dyes on a plurality of workpieces 200 such as a plurality of preprinted soft substrates continuously. The spraying and printing device 100 includes a supporting platform 10, a plurality of carrying disks 20, a plurality of clamping mechanisms 30, a frame 40, a linear driving mechanism 50, a printing mechanism 60, and a spraying mechanism 70.

The supporting platform 10 has a substantially T-shaped cross-section, and includes a top supporting surface 11. A bar-shaped mounting slot 12 is recessed from the top supporting surface 11 along a longitudinal direction of the supporting platform 10. The bar-shaped mounting slot 12 includes a bottom surface 121 and two parallel sidewalls 123. A plurality pairs of axial seats 13 are separately formed on the bottom surface 121, along the longitudinal length direction of the mounting slot 12. The plurality pairs of axial seats 13 of each couple are oppositely positioned adjacent to two sidewalls of the mounting slot 12. Each of the plurality pairs of axial seats 13 defines an axial hole 131 substantially perpendicular to the longitudinal length direction of the mounting slot 12.

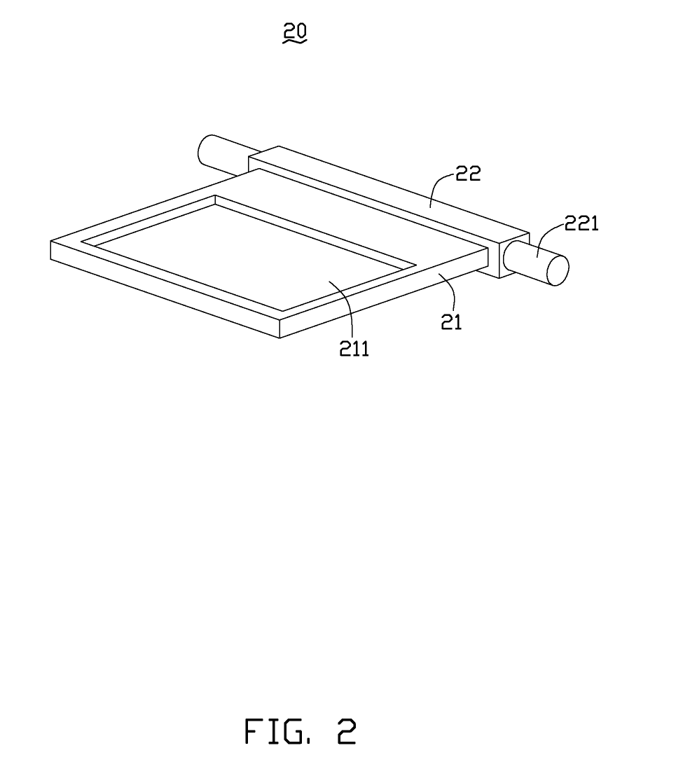

Also referring to FIG. 2, the plurality of carrying disks 20 are rotatably connected to the plurality pairs of axial seats 13, respectively, and separately received within the mounting slot 12 along the longitudinal length direction of the mounting slot 12. Each of the plurality of carrying disks 20 includes a carrying body 21 and a pivotal portion 22 formed on one end of the carrying body 21. The carrying body 21 is a substantially rectangular plate defining a carrying slot 211 positioned adjacent to the pivotal portion 22 for carrying a corresponding preprinted workpiece 200. The carrying slot 211 has a dimension slightly greater than that of the workpiece 200. The pivotal portion 22 is bar-shaped and includes two pivotal shafts 221 coaxially formed at opposite ends of the pivotal portion 22, corresponding to the two axial holes 131 of one pair of the plurality pairs of axial seats 13. The two pivotal shafts 221 of the pivotal portion 22 are respectively rotatably connected to the two axial holes 131 of one corresponding pair of the plurality pairs of axial seats 13. The carrying slot 211 of the carrying body 21 is positioned away from the bottom surface 121 of the mounting slot 12.

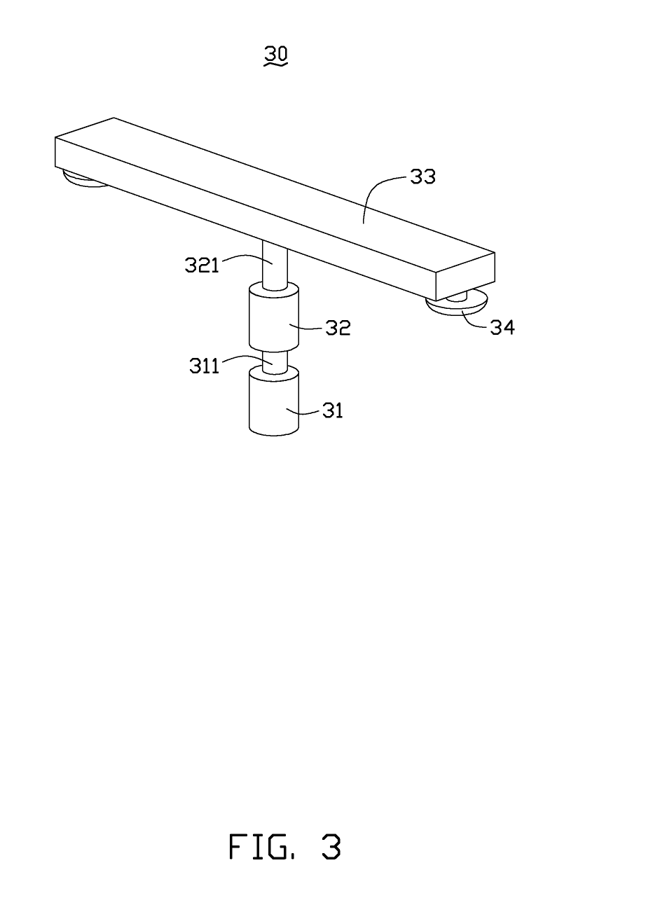

Also referring to FIG. 3, the plurality of clamping mechanisms 30 are rotatably mounted to the top supporting surface 11 of the supporting platform 10 and arranged on two sides of the mounting slot 12 for clamping and dropping the workpieces 200. Each of the plurality of clamping mechanisms 30 includes a first drive motor 31, a second drive motor 32, a rotating plate 33, and two suckers 34. The first drive motor 31 is mounted to the supporting platform 10 and includes a first drive shaft 311. The second drive motor 32 is coaxially assembled to one end of the first drive shaft 311 of the first drive motor 31, and includes a second drive shaft 321 coaxial with the first drive shat 311. The rotating plate 33 is mounted to a distal end of the second drive shaft 321. The two suckers 34 are mounted to opposite ends of the rotating plate 33 and both face toward the top supporting surface 11 of the supporting platform 10 for sucking and dropping the workpiece 200. In the illustrated embodiment, the first drive motor 31 is a linear motor for driving the second drive motor 32 to slide upwardly and downwards along the first drive shaft 311. The second drive motor 32 is configured for driving the rotating plate 33 to rotate.

The frame 40 is fixedly mounted on the top supporting surface 11 of the supporting platform 10. The frame 40 and the supporting platform 10 cooperatively define a receiving space 41. The plurality of carrying disks 20 and the plurality of clamping mechanisms 30 are received within the receiving space 41. In the illustrate embodiment, the frame 40 is a substantially rectangular frame including four sidewalls 42 connecting to each other in that order. Each of the four sidewalls 42 of the frame 40 defines a window 43 communicating with an inside of the receiving space 41. The plurality of clamping mechanisms 30 can be driven to pass through the window 43 of the frame 40 to clamp the workpiece 200. In one embodiment, the window 43 is filled in with transparent glasses for preventing outside dusts or object entering into the receiving space 41 of the frame 40.

The linear driving mechanism 50 is mounted to the frame 40 and positioned upon the top supporting surface 11 of the supporting platform 10. The linear driving mechanism 50 includes a guiding rail 51 and a moving member 52 movably and slidably sleeved on the guiding rail 51. The guiding rail 51 is parallel to the longitudinal length direction of the mounting slot 12 and positioned above the mounting slot 12.

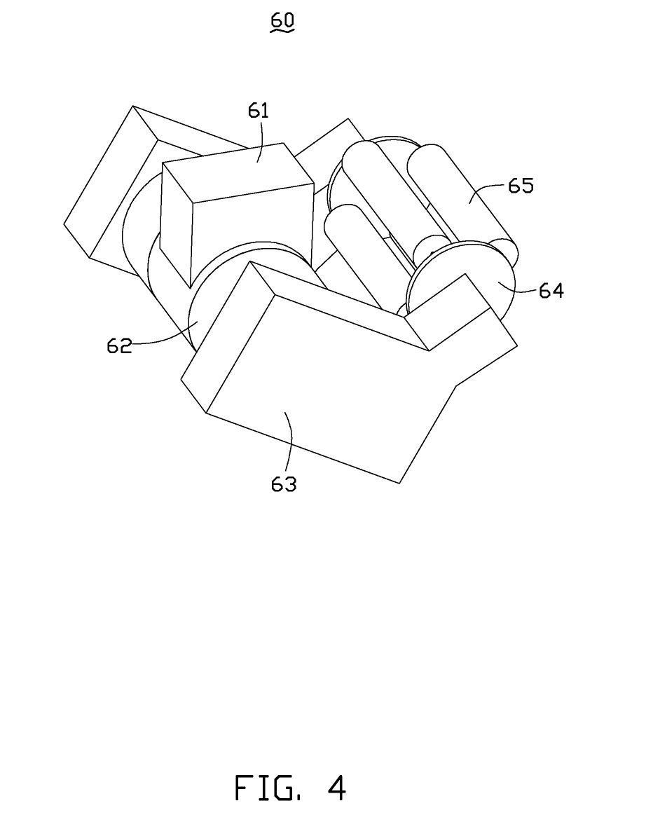

Also referring to FIG. 4, the printing mechanism 60 is mounted to the moving member 52 and positioned above the supporting platform 10 and received within the receiving space 41, for printing dyes on the workpiece 200. In the illustrated embodiment, the printing mechanism 60 includes a first connecting rod 61, a second connecting rod 62, two rockers 63, two first turntables 64, and at least one roller 65. One end of the first connecting rod 61 is fixed to the moving member 52. The other end of the first connecting rod 61 is fixed with a middle portion of the second connecting rod 62. The two rockers 63 are oppositely mounted to two ends of the second connecting rod 62. The two first turntables 64 are rotatably mounted to the two rockers 63, respectively, and positioned opposite to each other. The at least one roller 65 is rotatably assembled between the two first turntables 64 and arranged along the peripheral direction of the two first turntables 64 and parallel to the second connecting rod 62, for contacting with and printing dyes on the workpiece 200.

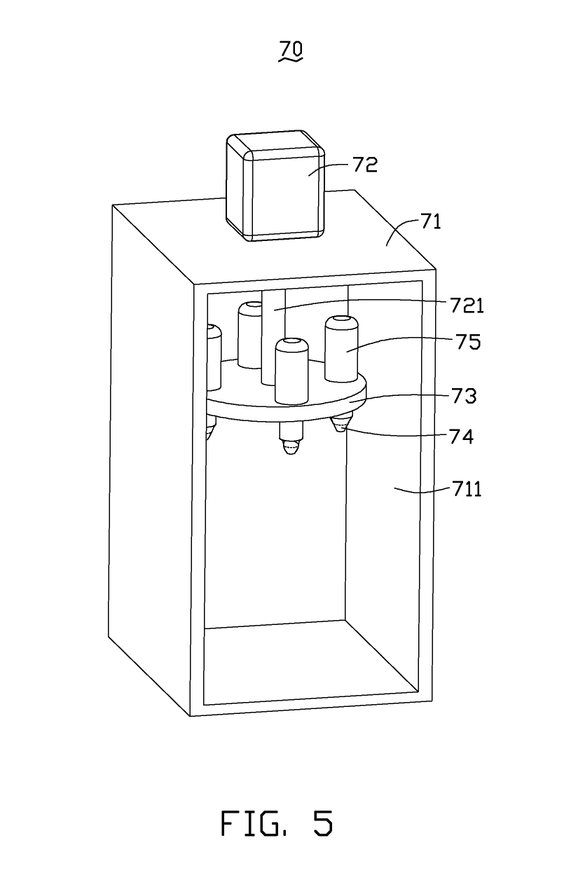

Also referring to FIG. 5, the spraying mechanism 70 is fixed to one end of the guiding rail 51 and positioned adjacent to one end of the frame 40, for spraying different dyes on the at least one roller 65. The spraying mechanism 70 includes a housing 71, a drive motor 72, a second turntable 73, a plurality of spraying nozzles 74, and a plurality of dye containers 75. The housing 71 defines a receiving chamber 711 communicating with the receiving space 41 of the frame 40. The drive motor 72 is mounted to a top end of the housing 71 and includes a third drive shaft 721 inserted into the receiving chamber 711 of the housing 71. The second turntable 73 is fixed to a distal end of the third drive shaft 721 and received within the receiving chamber 711. The plurality of dye containers 75 are mounted to the top end surface of the second turntable 73 and arranged adjacent to and along a periphery of the second turntable 73, separately. The plurality of dye containers 75 are configured for receiving different dyes. The plurality of spraying nozzles 74 are separately mounted to the bottom end surface of the second turntable 73, and connected to corresponding one of the plurality of dye containers 75, respectively, thereby getting dyes from the plurality of dye containers 75. The spraying mechanism 70 is capable of spraying different dyes on the at least one roller 65 of the printing mechanism 60 via different ones of the plurality of spraying nozzles 74.

In use, each of the plurality of clamping mechanisms 30 clamps and places the preprinted workpieces 200 into the corresponding carrying slots 211 of the plurality of carrying disks 20. The preprinted workpieces 200 are received within the corresponding carrying slots 211, respectively, and all partially exposed from corresponding ones of the plurality of carrying disks 20. The linear driving mechanism 50 drives the printing mechanism 60 to move toward the spraying mechanism 70, till the at least one roller 65 of the printing mechanism 60 positioned under corresponding ones of the plurality of spraying nozzles 74 of the spraying mechanism 70. The drive motor 72 drives the second turntable 73 to rotate thereby adjusting the plurality of spraying nozzles 74. The plurality of dye containers 75 supply different dyes for the plurality of spraying nozzles 74, such that, the different dyes are capable of being spurted out from corresponding ones of the plurality of spraying nozzles 74 toward the at least one roller 65 of the printing mechanism 60. The two first turntables 64 together with the at least one roller 65 are driven to rotate simultaneously. The printing mechanism 60 is driven to slide into the receiving space 41 of the frame 40 by the linear driving mechanism 50, and is adjusted to aim at and contact with the corresponding preprinted workpiece 200 manually or automatically. The linear driving mechanism 50 then drives the printing mechanism 60 to slide along the longitudinal length direction of the mounting slot 12 under an evenly speed back and forth to finish the spraying work to the workpiece 200.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A spraying and printing device, comprising:
a supporting platform for placing a plurality of preprinted workpieces;
a linear driving mechanism mounted above the supporting platform, and the linear driving mechanism comprising a guiding rail and a moving member slidably assembled to the guiding rail;
a printing mechanism mounted to the moving member and positioned above the supporting platform, the printing mechanism comprising at least one roller; and
a spraying mechanism assembled to one end of the guiding rail and comprising a plurality of spraying nozzles for spraying dyes on the at least one roller;
wherein, the at least one roller is driven by the moving member to slide along the guiding rail back and forth thereby printing different dyes on the plurality of preprinted workpieces.

2. The spraying and printing device of claim 1, wherein the supporting platform comprises a top supporting surface and a bar-shaped mounting slot recessed from the top supporting surface, the guiding rail is positioned above and parallel to the bar-shaped mounting slot; the spraying and printing device further comprises a plurality of carrying disks assembled into the bar-shaped mounting slot at intervals along a longitudinal length direction of the bar-shaped mounting slot for carrying the plurality of preprinted workpieces.

3. The spraying and printing device of claim 2, wherein the bar-shaped mounting slot comprises a bottom surface and two parallel sidewalls, the support platform further comprises a plurality pairs of axial seats separately formed on the bottom surface, along the longitudinal length direction of the bar-shaped mounting slot; each of the plurality of carrying disks is rotatably connected to each pair of the plurality pairs of axial seats.

4. The spraying and printing device of claim 3, wherein each pair of the plurality pairs of axial seats are oppositely positioned adjacent to the two parallel sidewalls of the bar-shaped mounting slot, each axial seat of the plurality pairs of axial seats defines an axial hole; each of the plurality of carrying disks comprises a carrying body and a pivotal portion formed on one end of the carrying body, the carrying body defines a carrying slot positioned adjacent to the pivotal portion for carrying one of the plurality of preprinted workpiece; each end of the pivotal portion is rotatably connected to the axial hole.

5. The spraying and printing device of claim 2, further comprising a plurality of clamping mechanisms rotatably mounted to the top supporting surface of the supporting platform and arranged on two sides of the bar-shaped mounting slot for clamping and dropping the plurality of preprinted workpieces.

6. The spraying and printing device of claim 5, wherein each of the plurality of clamping mechanisms comprises a first drive motor mounted to the supporting platform, a second drive motor, a rotating plate and two suckers, the second drive motor is coaxially and slidably assembled with the first drive motor; the rotating plate is rotatably mounted to the second drive motor, the two suckers are oppositely mounted to two ends of the rotating plate for sucking and dropping one of the plurality of preprinted workpieces.

7. The spraying and printing device of claim 6, wherein, the first drive motor is a linear driving mechanism for driving the second motor to slide upwardly and downwards relative to the supporting platform, the second drive motor is configured to drive the rotating plate to rotate.

8. The spraying and printing device of claim 7, wherein the printing mechanism further comprises a first connecting rod fixed with the moving member, a second connecting rod fixed with the first connecting rod, two rockers, and two first turntables; the two rockers are oppositely mounted to two ends of the second connecting rod, each of the two first turntables is rotatably mounted to each of the two rockers, and positioned opposite to each other; the at least one roller is rotatably assembled between the two first turntables and arranged along a peripheral direction of the two first turntables.

9. The spraying and printing device of claim 5, further comprising a frame mounted on the top supporting surface of the supporting platform, wherein the frame and the supporting platform cooperatively define a receiving space; the plurality of carrying disks and the plurality of clamping mechanisms are received within the receiving space, the linear driving mechanism is mounted to the frame and positioned upon the top supporting surface of the supporting platform.

10. The spraying and printing device of claim 8, wherein the spraying mechanism further comprises a housing, a drive motor mounted to the housing, a second turntable, and a plurality of dye containers; the housing defines a receiving chamber communicating with the receiving space of the frame, the second turntable is assembled to the drive motor and received within the receiving chamber; the plurality of dye containers together with the plurality of spraying nozzles are mounted to the second turntable; each of the plurality of dye containers is connected to each of the plurality of spraying nozzles, each of the plurality of dye containers is configured to supply dyes to each of the plurality of spraying nozzles.

11. A spraying and printing device configured to spray and print dyes on a plurality of preprinted workpieces continuously, the spraying and printing device comprising:
a supporting platform comprising a top supporting surface for placing the plurality of preprinted workpieces;
a motor mounted above the supporting surface of the supporting platform;
a printing mechanism mounted to the motor and positioned above the supporting surface, the printing mechanism comprising at least one roller; and
a spraying mechanism assembled to one end of the supporting platform for spraying dyes on the at least one roller, the spraying mechanism comprising a housing, a plurality of dye containers assembled within the housing, and a plurality of spraying nozzles, each of the plurality of spraying nozzles being connected to each of the plurality of dye containers;
wherein, the at least one roller is driven by the motor to move along a preset routine thereby printing dyes on the plurality of preprinted workpieces.

12. The spraying and printing device of claim 11, wherein the supporting platform comprises a bar-shaped mounting slot recessed from the top supporting surface, the spraying and printing device further comprises a plurality of carrying disks assembled into the bar-shaped mounting slot at intervals along a longitudinal length direction of the bar-shaped mounting slot for carrying the plurality of preprinted workpieces.

13. The spraying and printing device of claim 12, wherein the bar-shaped mounting slot comprises a bottom surface and two parallel sidewalls, the support platform further comprise a plurality pairs of axial seats separately formed on the bottom surface, along the longitudinal length direction of the bar-shaped mounting slot; each of the plurality of carrying disks is hinged to each pairs of the plurality pairs of axial seats.

14. The spraying and printing device of claim 12, further comprising a plurality of clamping mechanisms rotatably mounted to the top supporting surface of the supporting platform and arranged on two sides of the bar-shaped mounting slot for clamping and dropping the plurality of preprinted workpieces.

15. The spraying and printing device of claim 14, wherein each of the plurality of clamping mechanisms comprises a first drive motor mounted to the supporting platform, a second drive motor, a rotating plate and two suckers, the second drive motor is coaxially and slidably assembled with the first drive motor; the rotating plate is rotatably mounted to the second drive motor, the two suckers are oppositely mounted to two ends of the rotating plate for sucking and dropping one of the plurality of preprinted workpieces.

16. The spraying and printing device of claim 15, further comprising a frame mounted on the top supporting surface of the supporting platform, the frame and the supporting platform cooperatively define a receiving space; the plurality of carrying disks and the plurality of clamping mechanisms are received within the receiving space, a linear driving mechanism is mounted to the frame and positioned upon the top supporting surface of the supporting platform.
